(19) United States
(12) Patent Application Publication
(10) Pub. No.: US 2011/0199045 A1
(43) Pub. Date: Aug. 18, 2011

(54) POWER TRANSFER DEVICE AND METHOD

(75) Inventors: Shu Yuen Ron Hui, Shatin (HK); Wing Choi Ho, Kowloon (HK)

(73) Assignee: ConvenientPower HK Ltd, Shatin (HK)

(21) Appl. No.: 12/705,911

(22) Filed: Feb. 15, 2010

(51) Int. Cl. H02J 7/00

(52) U.S. Cl. 320/108; 307/104

(57) ABSTRACT

The present invention provides a power transfer device that wirelessly transfers AC power for charging at least one load, and an associated method of wirelessly transferring power. The device and method of the invention use phase-shift control to control the wireless transfer of the AC power.

### RELATED APPLICATIONS

This application claims priority to U.S. patent application Ser. No. 12/699,563, filed Feb. 3, 2010; and U.S. patent application Ser. No. 12/566,438, filed Sep. 24, 2009, which applications are incorporated herein by reference in their entirety and made a part hereof.

### FIELD OF THE INVENTION

The present invention relates to power transfer devices, particularly power transfer devices for wirelessly charging loads. The invention will be described in the context of power transfer devices that wirelessly charge the batteries of portable wireless communication devices. However, it will be appreciated that the invention is not limited to this particular use.

### BACKGROUND OF THE INVENTION

Traditional battery chargers transfer power to the batteries through electrical wires. Many switching control methods such as duty-cycle control, frequency control and phase-shift converter have been proposed for voltage regulation and soft-switching techniques to reduce the switching losses and radiated electromagnetic interference, in order to increase the energy efficiency and comply with electromagnetic compatibility requirements, respectively. Due to the small amount of radiated electromagnetic field involved (because the power transfer is carried out through wires), traditional power converters for battery charging applications do not cause significant interference with the signal transmission and reception in the antenna and other sub-systems of loads being charged, such as mobile phones.

However, unlike the design objectives of switched mode power supplies which focus mainly on energy efficiency and voltage regulation, power converters for wireless charging systems have to cope with not only the dynamic wireless power transfer, voltage regulation and efficiency requirements but also, and more importantly, the radio-frequency (RF) aspects of the systems. These RF aspects include the quality of the transmission and reception of RF signals in the electronic loads being charged by a wireless charging system and also the ability of bidirectional communication between the wireless charging system and the electronic loads being charged.

The AC electromagnetic flux generated by the power converter of a wireless charging system can cause interference with the signal transmission and reception in the antenna and other sub-systems of the electronic load being charged since energy is transferred through the AC magnetic flux to the load (the Applicant's previous U.S. patent application Ser. No. 12/566,438 titled “Antenna Network for Passive and Active Signal Enhancement” addressed other problems related to similar issues that are encountered in these wireless power transfer applications). The antenna and the sub-systems here form the entire electronic load. Therefore, the criteria for choosing the right control technique and switching method for power converters for wireless charging systems are distinctly different from those of traditional power converters for wired charging systems.

### SUMMARY OF THE INVENTION

The present invention provides a power transfer device that wirelessly transfers AC power for charging at least one load, the power transfer device having a phase-shift control means to control the wireless transfer of the AC power.

Preferably, the power transfer device includes a power converter for generating the AC power, the phase-shift control means controlling the power converter.

Preferably, the power transfer device wirelessly transfers the AC power at a transfer frequency using a spread-spectrum technique.

In another aspect, the present invention provides a method of wirelessly transferring AC power for charging at least one load, the method including controlling the wireless AC power transfer with phase-shift control.

Preferably, the method includes generating the AC power with a power converter, and wherein controlling the wireless AC power transfer with phase-shift control includes controlling the power converter with phase-shift control.

Preferably, the method includes using a spread-spectrum technique to wirelessly transfer the AC power at a transfer frequency.

In both the aspects described above, the power converter is preferably a DC-AC power converter, which is also known as an inverter.

### BRIEF DESCRIPTION OF THE FIGURES

Preferred embodiments in accordance with the best mode of the present invention will now be described, by way of example only, with reference to the accompanying figures, in which:

FIG. 1a is a schematic diagram of circuits of a wireless power transfer system incorporating a power transfer device in accordance with an embodiment of the present invention;

FIG. 1b is a schematic diagram of circuits of another wireless power transfer system;

FIG. 2a is a timing diagram showing the typical waveforms of an inverter operated under an embodiment of duty-cycle control;

FIG. 2b is a timing diagram showing the typical waveforms of the inverter of FIG. 2a operated under an embodiment of duty-cycle control where the duty cycle is large;

FIG. 2c is a timing diagram showing the typical waveforms of the inverter of FIG. 2a operated under an embodiment of duty-cycle control where the duty cycle is small;

FIG. 3a is a timing diagram showing the typical waveforms of an inverter operated under an embodiment of frequency control;

FIG. 3b is a timing diagram showing the typical waveforms of the inverter of FIG. 3a operated under an embodiment of frequency control at low frequency;

FIG. 3c is a timing diagram showing the typical waveforms of the inverter of FIG. 3a operated under an embodiment of frequency control at high frequency;

FIG. 4a is a timing diagram showing the typical waveforms of an inverter operated under phase-shift control in accordance with an embodiment of the present invention;

FIG. 4b is a timing diagram showing the typical waveforms of the inverter of FIG. 4a operated under phase-shift control with a small phase-shift angle in accordance with another embodiment of the present invention;

FIG. 4c is a timing diagram showing the typical waveforms of the inverter of FIG. 4a operated under phase-shift control with a large phase-shift angle in accordance with yet another embodiment of the present invention;

FIG. 5a is a timing diagram showing the typical waveforms of an inverter operated under phase-shift control in accordance with a further embodiment of the present invention;

FIG. 5b is a timing diagram showing the typical waveforms of the inverter of FIG. 5a operated under phase-shift control with a small phase-shift angle in accordance with another embodiment of the present invention;

FIG. 5c is a timing diagram showing the typical waveforms of the inverter of FIG. 5a operated under phase-shift control with a large phase-shift angle in accordance with yet another embodiment of the present invention;

FIG. 6 is a schematic diagram of a circuit of a wireless power transfer system in which an inverter is operated under an embodiment of voltage control;

FIG. 7a is a timing diagram showing the typical waveforms of an inverter operated under an embodiment of voltage control;

FIG. 7b is a timing diagram showing the typical waveforms of the inverter of FIG. 7a operated under an embodiment of voltage control with high DC link inverter voltage; and

FIG. 7c is a timing diagram showing the typical waveforms of the inverter of FIG. 7a operated under an embodiment of voltage control with low DC link inverter voltage.

### DETAILED DESCRIPTION OF THE BEST MODE OF THE INVENTION

Referring to the figures, there is provided a power transfer device 1 that wirelessly transfers AC power for charging at least one load 2, the power transfer device having a phase-shift control means 3 to control the wireless transfer of the AC power.

The power transfer device 1 includes a power converter 4 for generating the AC power, and the phase-shift control means 3 controls the power converter. In the present embodiment, the power converter 4 is a DC-AC power converter, which is also known as an inverter.

The power transfer device 1 includes a primary winding Lₚᵣᵢ for inductively transferring the AC power to a secondary winding L_{sec}, thereby wirelessly transferring the AC power. The secondary winding L_{sec} includes a series capacitor C, for reducing any leakage inductance. The secondary winding L_{sec} is also connected to a rectifier 5, which is preferably a synchronous rectifier.

The secondary winding L_{sec}, forms part of the load 2. Preferably, the power transfer device 1 wirelessly transfers AC power for charging a plurality of loads 2. Also, these loads 2 can be of different types. For example, they can include mobile phones, laptop computers, or any other portable electronic devices, which may or may not be capable of wireless communication.

In further detail, the DC-AC power converter 4 includes two pairs of switches M1, M2, M3, and M4. The off-diagonal switches work as a pair, that is, switches M1 and M4 are one pair and switches M2 and M3 are the other pair. The phase-shift control means 3 varies the AC power by adjusting a phase angle α between gating signals of each pair of switches. Each switch M1, M2, M3, and M4 is operated at a constant frequency and a constant duty-cycle.

As will be described in greater detail below, not only does the use of phase-shift control result in better efficiency, lower cost, as well as addressing the voltage floating problem, but it also reduces or minimizes RF interference. For example, where one of the loads 2 is a wireless communication device (such as a mobile phone) having a communication bandwidth, the use of the phase-shift control means 3 reduces or minimizes interference signals within the communication bandwidth. The use of the phase-shift control means 3 also reduces or minimizes interference signals within the power transfer device 1 itself.

Also, in another preferred embodiment, the power transfer device 1 wirelessly transfers the AC power at a transfer frequency using a spread-spectrum technique. The spread-spectrum technique is at least one of dithering, pseudo-random, random, chaotic, and modulated type, and thereby varies the transfer frequency. Generally, the spread-spectrum technique varies the transfer frequency within a transfer bandwidth that maximizes the energy efficiency of the AC power transfer by the power transfer device 1.

As mentioned above, the power transfer device 1 utilizes switching to generate the AC power. The spread-spectrum technique varies at least one of the characteristics of the switching. In particular, the spread-spectrum technique varies at least one of switching frequency, switching pulse width, and switching pulse position.

In one embodiment, the spread-spectrum technique utilizes a direct sequence spread-spectrum method.

Where one of the loads 2 is a wireless communication device (such as a mobile phone) having a communication bandwidth, the spread-spectrum technique reduces or minimizes interference signals within the communication bandwidth. The spread-spectrum technique also reduces or minimizes interference signals within the power transfer device 1 itself.

The use of a spread-spectrum technique in wireless power transfer applications such as that presently contemplated is described in further detail in the Applicant's previous U.S. patent application Ser. No. 12/699,563, which is incorporated herein by reference in its entirety. It will be appreciated that the spread-spectrum techniques and other features of the invention disclosed in U.S. patent application Ser. No. 12/699,563 can be combined with embodiments of the present invention.

In order to demonstrate the surprising and unexpected suitability of using phase-shift control in wireless power transfer applications, such as those contemplated in the present invention, the following analysis is provided. Control methods for power converters are analyzed in the context of wireless battery charging systems with an emphasis on energy efficiency and interference between the charging flux of the charging system (such as those including a charging pad) and the antenna and other sub-systems of a load being charged.

More specifically, analysis is carried out for the following methods for controlling the wireless power transfer:

(i) duty-cycle control;

(ii) frequency control;

(iii) phase-shift control (two versions, referred to as Schemes I and II); and

(iv) voltage control.

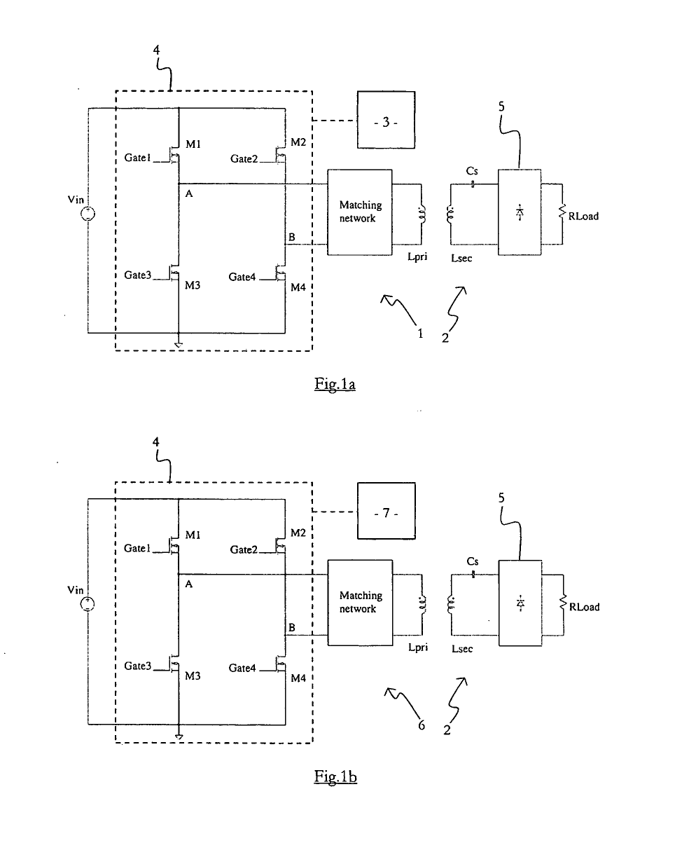

FIGS. 1a, 1b, and 6 show typical circuits for a wireless power transfer system. FIG. 1a includes the power transfer device 1, which was broadly described earlier, that incorporates method (iii). FIGS. 1b and 6 show a similar system that includes a power transfer device 6 that can incorporate one of the methods (i), (ii), and (iv), and more specifically, includes control means 7 that can implement one of those methods. For a given constant input DC voltage source, a primary side of the system includes one of the power transfer devices 1 and 6, which in turn, includes the DC-AC power converter 4 (also called a power inverter) driving the primary winding Lₚᵣᵢ or a group of primary windings (preferably through a matching network). A secondary side of the system includes a secondary module (in the form of the load 2), which in turn, includes the secondary winding L_{sec}, preferably with a series capacitor such as Cₛ, and the rectifier circuit 5, which can be a synchronous rectifier. The series capacitor Cₛ in the secondary winding L_{sec} is preferred because it allows the effect of the leakage inductance in this loosely coupled system to be cancelled so that the power transfer can be maximized. In general, the off-diagonal switches of the power inverter 4 work as a pair (i.e. M1 and M4 as a pair and M2 and M3 as another pair, as mentioned earlier).

A. Duty-Cycle Control

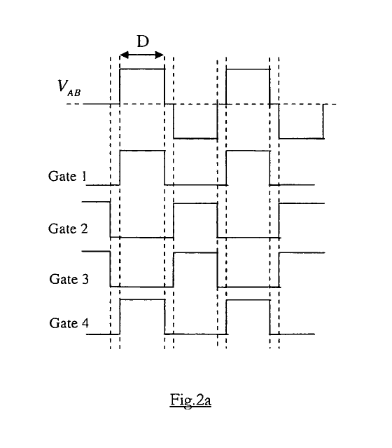

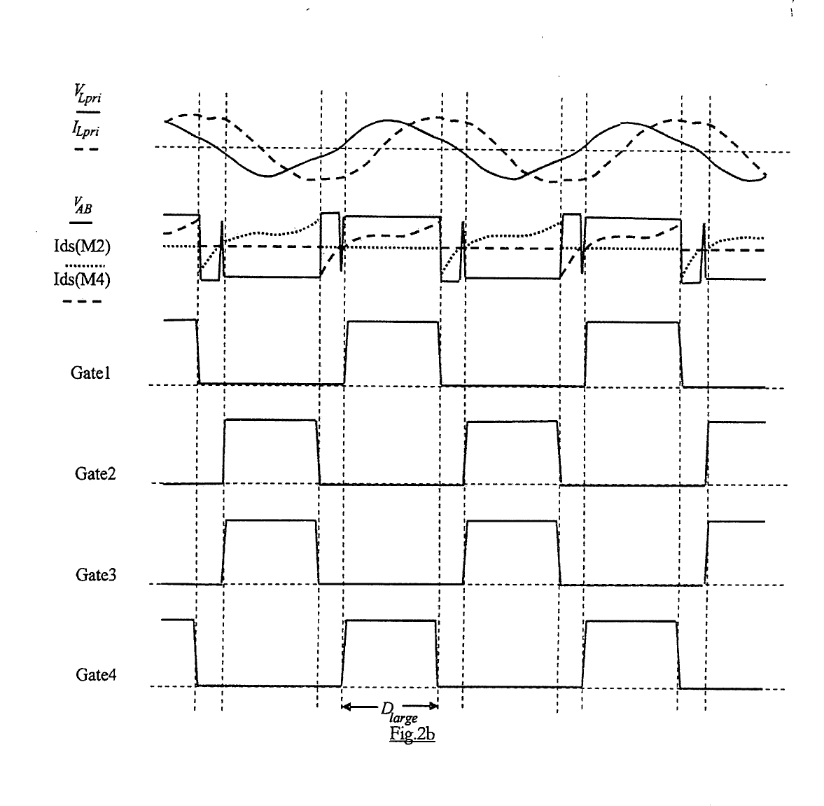

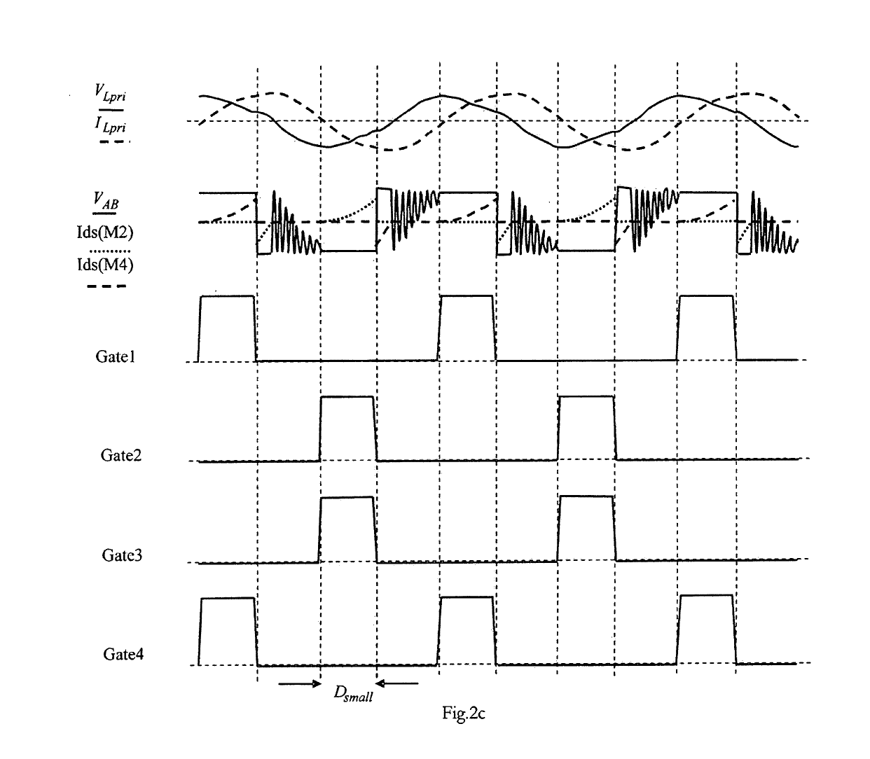

The cycle control is carried out by controlling the duty cycle D of the switches M1, M2, M3, and M4. FIG. 2a shows typical waveforms of the gate signals of the four switches of the inverter 4 and also the AC output voltage V_{AB} of the power inverter 4. Usually the inverter 4 is operated at constant switching frequency. There is a constant 90-degree phase shift between the switching patterns of the diagonal switch pairs. Because of the constant phase shift, the output voltage magnitude is controlled by varying the duty cycle from 0 to 0.5. The output voltage increases with increasing duty cycle. It is important to note that the duty-cycle control scheme is easy to design. The duty cycle of a diagonal pair of switches (e.g. M1 and M4) are identical. Its duty cycle is varied and this duty cycle control method can control the magnitude of the output voltage V_{AB} without requiring a front DC-DC converter stage to vary the DC link voltage for the power inverter 4.

FIG. 2b and FIG. 2c show the simulated waveforms of the duty-cycle control method when the duty cycle is large and small, respectively. Controlling the duty cycle can control the power flow. However, for wireless energy transfer systems, duty-cycle control has the following disadvantages:

(i) The primary current is distorted and not sinusoidal, regardless of whether the duty cycle is large or small. The distorted current indicates the presence of current harmonics and harmonic losses and thus poor energy efficiency. The harmonic currents will cause harmonic heating in the primary winding, resulting in high conduction loss and poor energy efficiency.

(ii) When the duty cycle is small, sharp voltage ringing occurs across V_{AB}. The sharp voltage pulses (V_{AB}) and its high-frequency harmonics would be a source of electromagnetic interference (EMI) to the load, and therefore causing RF signal jamming to the antenna of the load.

(iii) Bi-directional communication (such as frequency or amplitude modulation and demodulation methods) between the primary charging system and the load on the secondary side cannot be easily achieved in the duty-cycle control scheme.

(iv) When the duty cycle is very small, the current could become discontinuous. Consequently, there are frequent moments that all the four switches are turned off simultaneously, resulting in the primary winding ‘floating’. With unpredictable floating voltage in the primary winding, the bidirectional communication signals can be affected.

B. Frequency Control Scheme

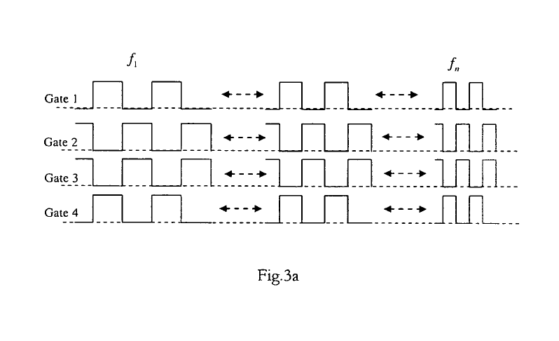

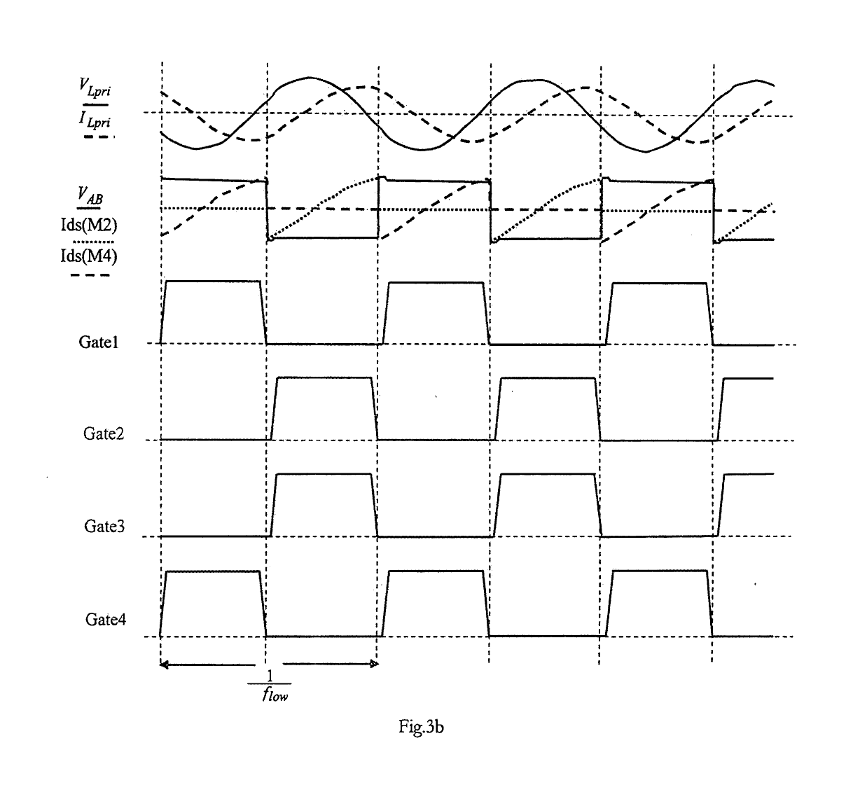

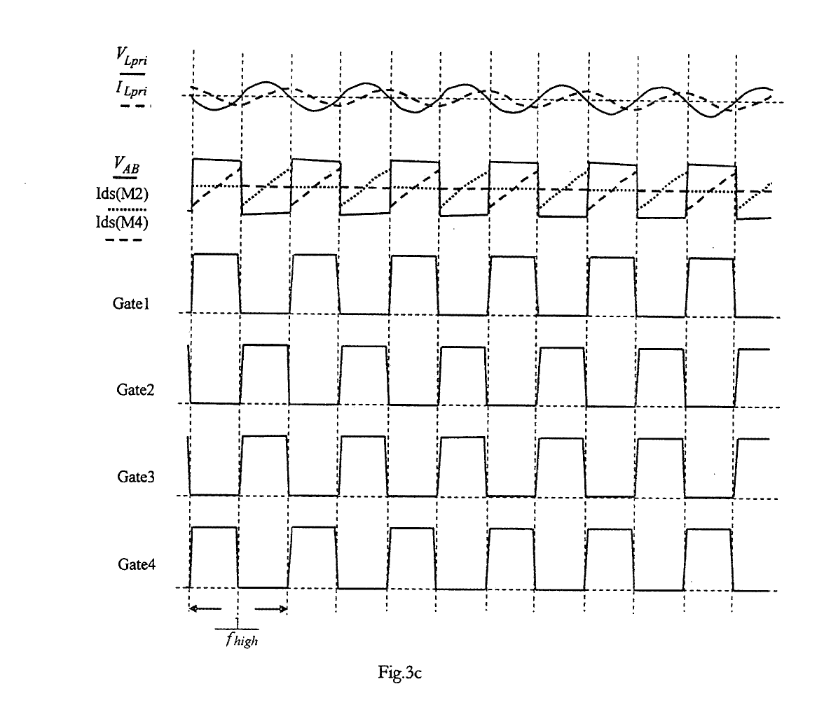

A frequency controlled inverter 4 usually uses a resonant circuit consisting of an inductor and a capacitor as the matching network. By changing the frequency at constant duty cycle, the inverter 4 can vary the output voltage according to the voltage gain profile of the LC resonant circuit. FIG. 3a shows the timing diagram of the gating signals of the frequency control scheme. The simulated waveforms of the frequency-control scheme at low and high frequency operations are included in FIG. 3b and FIG. 3c, respectively. It can be seen that frequency control can vary the power flow. If the frequency is reduced, the current and therefore power increases, and vice versa.

The frequency control scheme is easy to implement and has been commonly adopted in dimmable electronic ballasts for lighting applications. It can vary the output voltage of the inverter 4 without using a front power stage to vary the DC link voltage of the inverter. However, for wireless energy transfer systems, frequency control has the following disadvantages:

(i) The frequency-dependent voltage gain of the LC resonant circuit does not change linearly with frequency, making the power control nonlinear.

(ii) For a secondary module 2 with a fixed inductor and series capacitor (i.e. secondary resonant circuit), only when the inverter frequency matches the secondary resonant frequency does the operation achieve optimal operating frequency. All other frequencies do not match the secondary resonant frequency and energy efficiency cannot be maximized.

(iii) Frequency control is not suitable for common secondary circuit design (which has a single resonant frequency as explained in (ii)).

(iv) The wide frequency range of the inverter 4 also means that the interference between the AC flux of this varying frequency and the antenna signal will be complicated. The noise induced will spread over a wider spectrum, making it difficult to reduce the signal mixing and jamming effects due to this interference.

C. Phase-Shift Control Schemes

(a) Phase-Shift Control—Scheme I

The phase-shift control Scheme I operates the inverter 4 at constant frequency and constant duty-cycle, with each switch operated at half the duty-cycle. Thus, this means that each diagonal pair of the switches operates for half of the cycle. The output voltage magnitude is controlled by varying the phase shift of the switching patterns of the two sets of diagonal switch pairs. That is to say, the control scheme varies the output voltage V_{AB} by adjusting a phase angle α between the gating signals of each diagonal pair of the switches (M1 and M4 as one pair, and M2 and M3 as another pair). In actual operation, each pair of the switches switch at a duty cycle of 0.5 minus the dead time for transition from one pair of switches to the other pair, that is, their duty cycles remain at or close to 0.5. In this way, an AC voltage can be generated in the output of the phase-shift inverter 4.

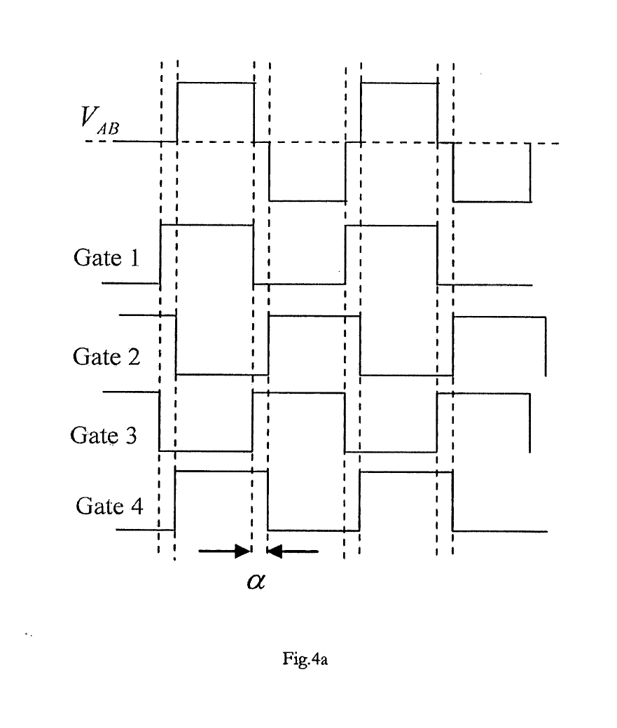

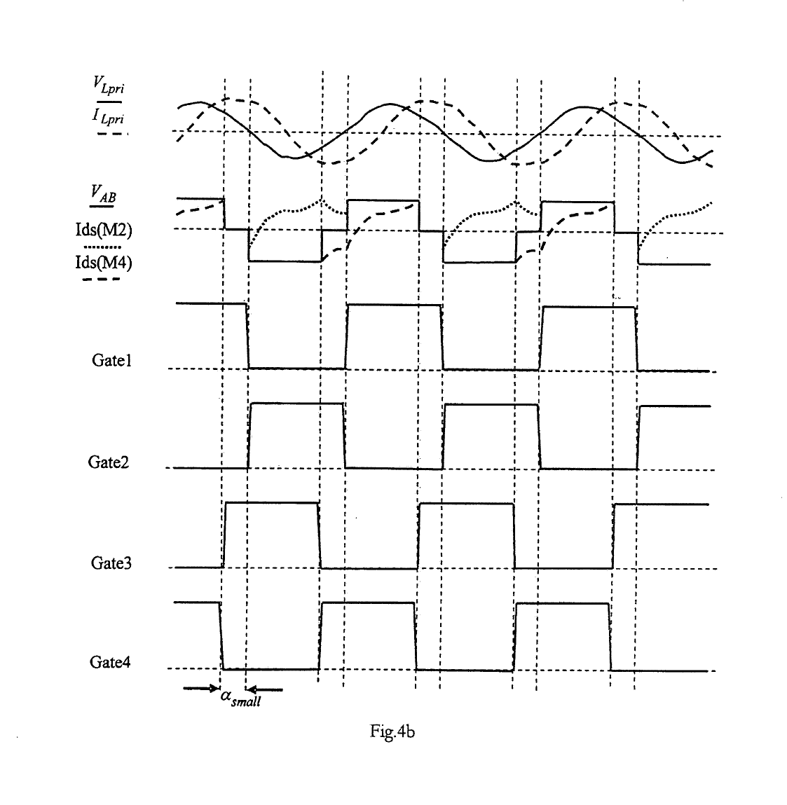

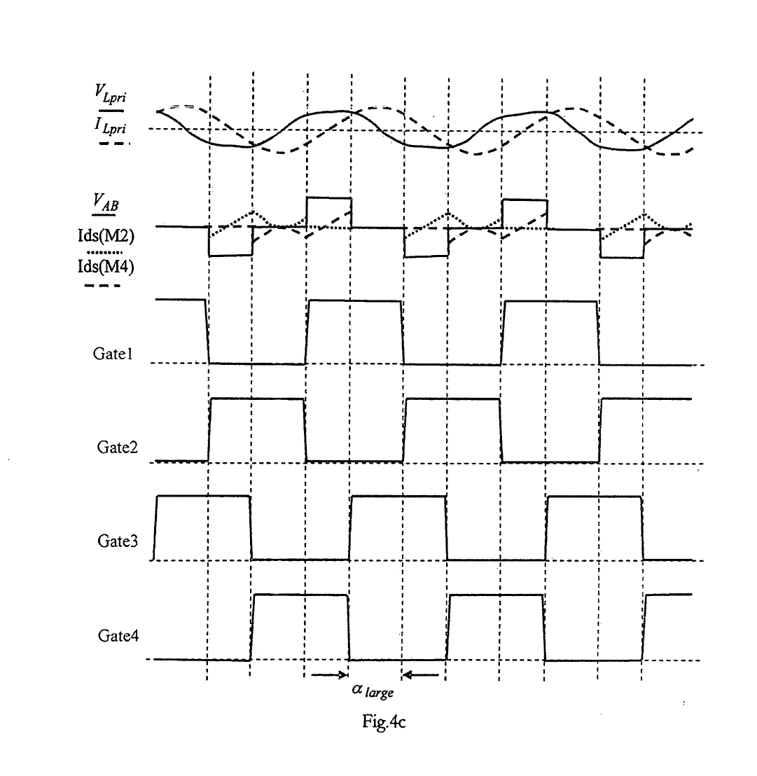

The timing diagram of the gating signals and the inverter output voltage is shown in FIG. 4a. Although the inverter output voltage waveform looks like that of the duty-cycle control in FIG. 2a, there are several major differences that make this scheme have different features from those of the duty-cycle control. Firstly, the gating signals of the diagonal pair of switches are not identical. There exists the phase angle α between them as shown in FIG. 4a. Increasing a can reduce the primary voltage and current and therefore power. Since power control can be carried out in one power stage, high efficiency can be achieved. Secondly, each switch M1, M2, M3, and M4 is operated at a respective constant duty-cycle. In this particular scheme, each switch is operated at half duty-cycle. The continuous conduction states of the respective switches allows the current in the primary winding Lₚᵣᵢ and the matching network to flow continuously and remain in a sinusoidal manner, therefore reducing current harmonics, harmonic heating loss in the winding and electromagnetic interference (EMI) emitted from the electromagnetic flux generated in the primary winding. By contrast, under a duty-cycle control scheme, there is a constant 90-degree phase shift between the switching patterns of the diagonal switch pairs. Because of the constant phase shift, the output voltage magnitude is controlled by varying the duty cycle from 0 to 0.5.

The phase-shift Scheme I is easy to implement. Because of the large duty cycle, the harmonics can be minimized. Since the output voltage can be controlled by adjusting the phase angle, there is no need to use a front stage DC-DC converter to vary the DC link voltage of the inverter 4. Thus, the energy efficiency can be high. As the current in the primary winding can flow continuously, there is no ‘voltage floating” problem in the primary winding Lₚᵣᵢ.

The only disadvantage is that this method is only applicable for a full-bridge inverter (and not a half-bridge inverter). However, a full-bridge is acceptable in the wireless charging application because the DC link voltage of the inverter 4 is usually low and typically between 10V to 20V. Using a full-bridge in such a low-voltage environment is useful in full utilization of the limited voltage range.

(b) Phase-Shift Control—Scheme II

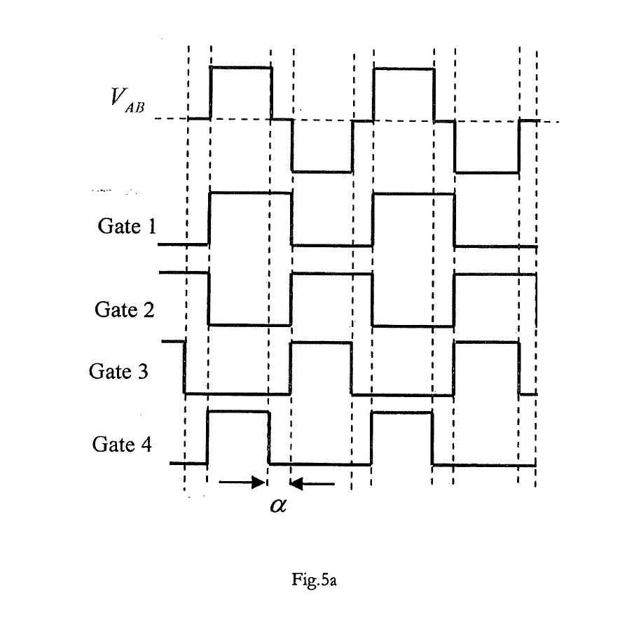

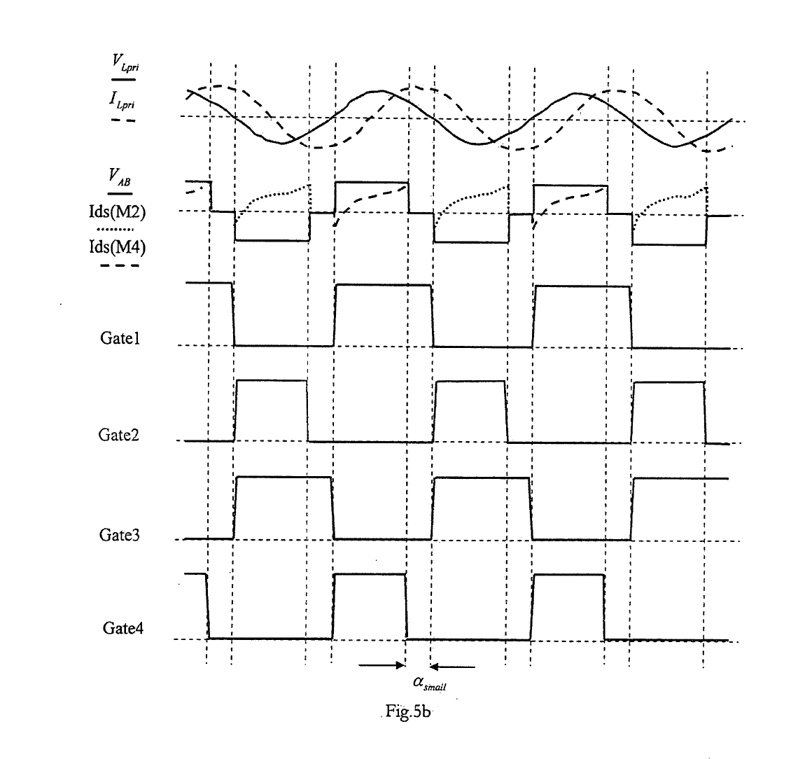

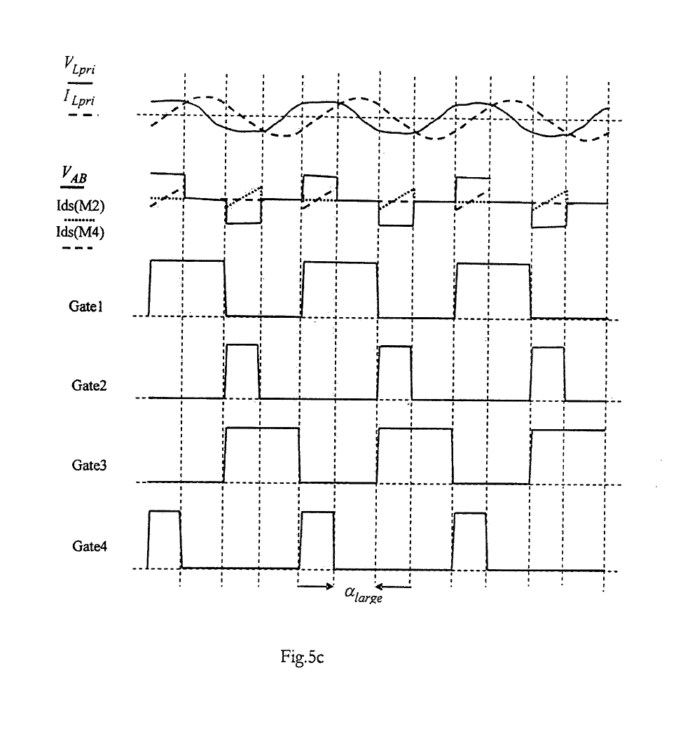

The phase-shift control Scheme II is a modified version of Scheme I. This is also a constant-frequency method. The gate signals Gate 1 for M1 and Gate 2 for M2 are kept out of phase. The pulse width of Gate 4 for M4 (of the diagonal pair M1 and M4) is controlled with a phase angle α with respective to Gate 1 as shown in timing diagram of FIG. 5a. The simulated waveforms of such a scheme with small and large phase shift angles are shown in FIG. 5b and FIG. 5c, respectively. Similar to Scheme I, increasing the phase shift angle can reduce the power. With only one power stage, this scheme can achieve high efficiency. Good sinusoidal current waveforms are observed in both cases, implying good RF performance.

D. Voltage Control Method

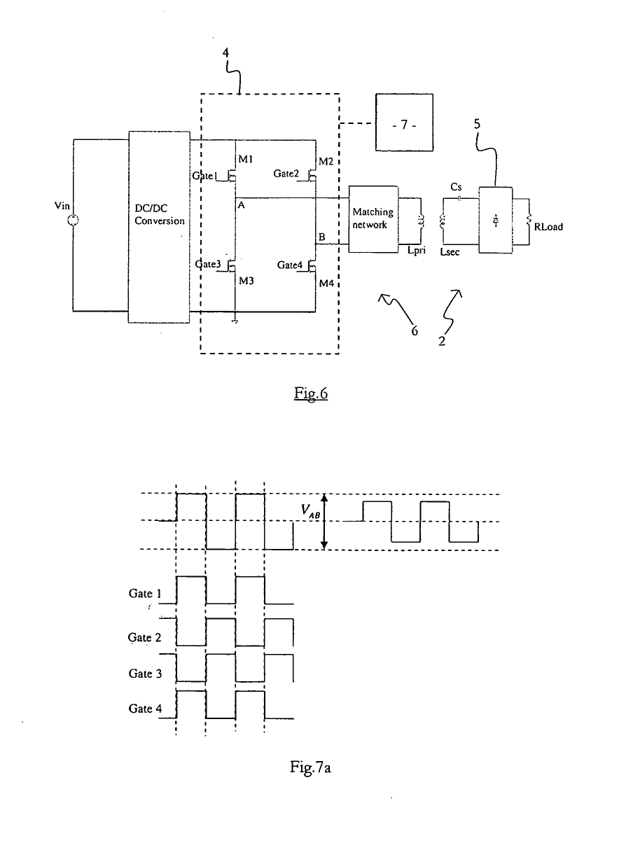

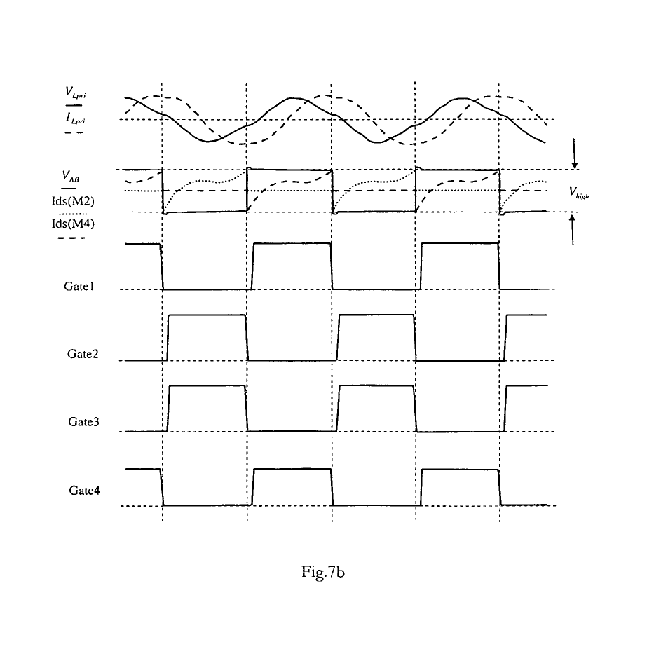

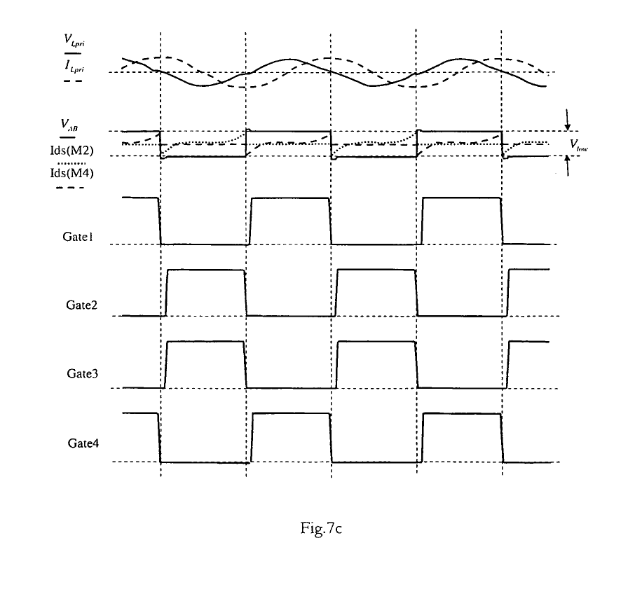

Unlike the previous control schemes that employ the circuit depicted in the schematic diagram of FIG. 1, the voltage control scheme uses an extra DC-DC power converter stage (labeled DC/DC Conversion) to control the DC link voltage for the power inverter as shown in FIG. 6. The corresponding timing diagram and inverter output voltage waveform are shown in FIG. 7a. The gating signals of the diagonal pair of switches are identical and at a full duty cycle of about 0.5 (except for a small dead time between them in practice to avoid shoot-through). The switching frequency of the inverter 4 remains constant. The inverter 4 basically controls the frequency of its output voltage V_{AB}. The magnitude of the inverter output voltage is controlled by the front-end power converter that varies the DC link voltage for the inverter. FIG. 7b and FIG. 7c show the simulated waveforms of this scheme with high and low DC link voltages respectively. It can be seen that the primary voltage and current can be controlled by controlling the DC link voltage in the front power stage.

The voltage control scheme has the following advantages. It is simple in concept and the power control is linear and simple to implement. Individual power converter/inverter modules can be designed independently and put together. The current in the primary winding can remain sinusoidal and thus minimizing harmonic interference and signal jamming problem with the antenna (i.e. good RF performance). However, there are disadvantages for the voltage control scheme, as follows:

(i) The two power conversion stages (i.e. the requirement of one extra power converter for controlling the DC link voltage for the inverter) will reduce the energy efficiency of the entire wireless energy transfer system.

(ii) More components and higher costs result from one more power converter.

After analyzing the four types of control schemes and considering the energy efficiency and the RF performance together, their advantages and disadvantages are summarized in Table 1 below. Surprisingly and unexpectedly, it can be seen that the two phase-shift control schemes stand out to be the best schemes among all the schemes under consideration. While phase-shift control may require relatively expensive customized integrated control circuits, it can be implemented with digital control (such as a microprocessor unit, which is good for complex control implementation). Due to the use of one power stage, the cost is low, energy efficiency is high, bidirectional communication is feasible and the RF performance is good. Thus, the phase-shift control scheme is the optimal scheme for wireless energy transfer system when the RF aspects of the load or loads are considered.

TABLE 1
Summary of disadvantages and advantages of control schemes.

| | Disadvantages | Advantages |
|---|---|---|
| Duty-Cycle | 1. Serious current harmonics. | 1. Simple to design. |
| Control | 2. Harmonics cause conduction loss | 2. Without front-stage power |
| | and reduce energy efficiency. | converter. |
| | 3. Harmonics cause signal | |
| | mixing/jamming effect in antenna. | |
| | 4. Potential problem in stability due to | |
| | voltage floating. | |
| | 5. Potential problem in amplitude | |
| | modulation/demodulation | |
| | (communication). | |
| | 6. Poor RF performance. | |
| Frequency | 1. Non-linearity | 1. Applicable for higher power. |
| Control | 2. More expensive components due to | 2. Simple to design. |
| | high frequency for low power. | 3. Without front-stage power |
| | 3. Interfered by secondary resonance. | converter. |
| | 4. Possible interference to different | |
| | frequency bands (poor EMC/EMF). | |
| Phase-Shift | 1. Relatively complex control scheme. | 1. Without front-stage power |
| Control | 2. Can only be applied to full-bridge | converter (thus, higher efficiency |
| | power inverter. | and lower cost). |
| | | 2. Less RF interference. |
| | | 3. No voltage floating problem. |
| Voltage | 1. Poor efficiency due to front-stage | 1. Simple and off-the-shelf |
| Control | power converter. | design. |
| | 2. More components (add | 2. Good waveform on coil (less |
| | additional circuits), high cost. | interference). |
| | | 3. No voltage floating problem. |

The present invention incorporates phase-shift control, together with the surprising and unexpected results and advantages this type of control offers in the context of wireless power transfer applications, such as those the present invention contemplates. These advantages include the favourable RF aspects as well as higher energy efficiency and lower costs.

As described previously, in order to further enhance the signal reception and transmission of the antenna in loads such as wireless communication devices (for example, mobile phones) and to avoid interference caused by the charging flux to any sub-system within an electronic load (being charged on, for example, a charging pad), the phase-shift control scheme in some preferred embodiments of the invention incorporate spread-spectrum switching techniques so that the switching noise picked up by the antenna (and other sub-systems) due to the charging flux from the wireless charging pad can be spread over a wide spectrum (as approximately white noise). Spread-spectrum switching techniques include, but are not limited to, various forms of random PWM methods, chaotic PWM methods, frequency modulation, and direct-sequence-spread-spectrum DSSS methods. As mentioned above, the use of a spread-spectrum technique in wireless power transfer applications such as that presently contemplated is described in further detail in the Applicant's previous U.S. patent application Ser. No. 12/699,563, which is incorporated herein by reference in its entirety. It will be appreciated that the spread-spectrum techniques and other features of the invention disclosed in U.S. patent application Ser. No. 12/699,563 can be combined with embodiments of the present invention.

The Applicant's previous U.S. patent application Ser. No. 12/566,438 disclosed solutions to other problems that are, like some of those being addressed presently, related to the quality of the transmission and reception of RF signals by loads being charged by wireless power transfer systems. U.S. patent application Ser. No. 12/566,438 is also incorporated herein by reference in its entirety. It will be appreciated that the features of the invention disclosed in U.S. patent application Ser. No. 12/566,438 can be combined with embodiments of the present invention.

The present invention also provides, in another aspect, a method of wirelessly transferring AC power for charging at least one load. The method includes controlling the wireless AC power transfer with phase-shift control. Preferably, the method includes using a spread-spectrum technique to wirelessly transfer the AC power at a transfer frequency. It will be appreciated that the foregoing describes preferred embodiments of this method. For example, in one embodiment, the method wirelessly transfers AC power for charging the load 2, and includes generating the AC power with the power converter 4. Further, controlling the wireless AC power transfer with phase-shift control includes controlling the power converter 4 with phase-shift control.

Thus, the present invention is related to the use of phase-shift control, preferably combined with spread-spectrum switching techniques, and in the context of power converters, for achieving overall optimal power transfer in wireless energy transfer systems (particularly for charging) in terms of energy efficiency, harmonic content, and the reduction of radio interference (or jamming) to the transmission and reception of radio-frequency (RF) signals in the antenna and other sub-systems of portable electronic devices being charged on the wireless charging systems.

Although the invention has been described with reference to specific examples, it will be appreciated by those skilled in the art that the invention can be embodied in many other forms. It will also be appreciated by those skilled in the art that the features of the various examples described can be combined in other combinations.

What is claimed is:

1. A power transfer device that wirelessly transfers AC power for charging at least one load, the power transfer device having a phase-shift control means to control the wireless transfer of the AC power.

2. A power transfer device according to claim 1 including a power converter for generating the AC power, the phase-shift control means controlling the power converter.

3. A power transfer device according to claim 2 wherein the power converter is a DC-AC power converter.

4. A power transfer device according to claim 3 wherein the DC-AC power converter includes two pairs of switches.

5. A power transfer device according to claim 4 wherein the phase-shift control means varies the AC power by adjusting a phase angle between gating signals of each pair of switches.

6. A power transfer device according to claim 4 wherein each switch is operated at a constant frequency and a constant duty-cycle.

7. A power transfer device according to claim 1 wherein the power transfer device wirelessly transfers the AC power at a transfer frequency using a spread-spectrum technique.

8. A power transfer device according to claim 7 wherein the power transfer device utilizes switching to generate the AC power and the spread-spectrum technique varies at least one of the characteristics of the switching.

9. A power transfer device according to claim 8 wherein the spread-spectrum technique varies at least one of switching frequency, switching pulse width, and switching pulse position.

10. A power transfer device according to claim 7 wherein the spread-spectrum technique is at least one of dithering, pseudo-random, random, chaotic, and modulated type, and thereby varies the transfer frequency.

11. A power transfer device according to claim 7 wherein the spread-spectrum technique varies the transfer frequency within a transfer bandwidth that maximizes the energy efficiency of the AC power transfer by the power transfer device.

12. A power transfer device according to claim 7 wherein the spread-spectrum technique utilizes a direct sequence spread-spectrum method.

13. A power transfer device according to claim 7 wherein the load is a wireless communication device having a communication bandwidth, and the spread-spectrum technique reduces or minimizes interference signals within the communication bandwidth.

14. A power transfer device according to claim 7 wherein the spread-spectrum technique reduces or minimizes interference signals within the power transfer device.

15. A power transfer device according to claim 1 including a primary winding for inductively transferring the AC power to a secondary winding, thereby wirelessly transferring the AC power.

16. A power transfer device according to claim 15 wherein the secondary winding includes a series capacitor for reducing any leakage inductance.

17. A power transfer device according to claim 15 wherein the secondary winding is connected to a rectifier.

18. A power transfer device according to claim 17 wherein the rectifier is a synchronous rectifier.

19. A power transfer device according to claim 1 wherein the load is a wireless communication device having a communication bandwidth, and use of the phase-shift control means reduces or minimizes interference signals within the communication bandwidth.

20. A power transfer device according to claim 1 wherein use of the phase-shift control means reduces or minimizes interference signals within the power transfer device.

21. A power transfer device according to claim 1 wherein the load is capable of signal transmission or reception, the power transfer device includes a coupling area in which the load can be placed to allow the power transfer device to wirelessly transfer the AC power to the load, and the power transfer device further includes an antenna network for enhancing signal transmission or reception of the load, the antenna network including one or more antennas, each having a coupling portion and a radiating portion, the coupling portion being distributed across the coupling area and the radiating portion being located away from the coupling area, whereby signal transmission or reception of the load can occur through the radiating portion when the load is located within the coupling area.

22. A method of wirelessly transferring AC power for charging at least one load, the method including controlling the wireless AC power transfer with phase-shift control.

23. A method according to claim 22 including generating the AC power with a power converter, and wherein controlling the wireless AC power transfer with phase-shift control includes controlling the power converter with phase-shift control.

24. A method according to claim 23 wherein the power converter is a DC-AC power converter.

25. A method according to claim 24 wherein the DC-AC power converter includes two pairs of switches.

26. A method according to claim 25 wherein controlling the power converter with phase-shift control includes varying the AC power by adjusting a phase angle between gating signals of each pair of switches.

27. A method according to claim 25 including operating each switch at a constant frequency and a constant duty-cycle.

28. A method according to claim 22 including using a spread-spectrum technique to wirelessly transfer the AC power at a transfer frequency.

29. A method according to claim 28 including generating the AC power by switching and wherein the spread-spectrum technique is used to vary at least one of the characteristics of the switching.

30. A method according to claim 29 wherein the spread-spectrum technique is used to vary at least one of switching frequency, switching pulse width, and switching pulse position.

31. A method according to claim 28 wherein the spread-spectrum technique is at least one of dithering, pseudo-random, random, chaotic, and modulated type, and thereby varies the transfer frequency.

32. A method according to claim 28 wherein the spread-spectrum technique is used to vary the transfer frequency within a transfer bandwidth that maximizes the energy efficiency of the AC power transfer.

33. A method according to claim 28 wherein the spread-spectrum technique utilizes a direct sequence spread-spectrum method.

34. A method according to claim 28 wherein the load is a wireless communication device having a communication bandwidth, and the spread-spectrum technique is used to reduce or minimize interference signals within the communication bandwidth.

35. A method according to claim 28 including using a power transfer device to wirelessly transfer the AC power, and wherein the spread-spectrum technique is used to reduce or minimize interference signals within the power transfer device.

36. A method according to claim 22 wherein the AC power is wirelessly transferred by using a primary winding to inductively transfer the AC power to a secondary winding.

37. A method according to claim 36 wherein the secondary winding includes a series capacitor for reducing any leakage inductance.

38. A method according to claim 36 wherein the secondary winding is connected to a rectifier.

39. A method according to claim 38 wherein the rectifier is a synchronous rectifier.

40. A method according to claim 22 wherein the load is a wireless communication device having a communication bandwidth, and controlling the wireless AC power transfer with phase-shift control reduces or minimizes interference signals within the communication bandwidth.

41. A method according to claim 22 including using a power transfer device to wirelessly transfer the AC power, and wherein controlling the wireless AC power transfer with phase-shift control reduces or minimizes interference signals within the power transfer device.
